(19) United States
(12) Patent Application Publication
(10) Pub. No.: US 2025/0284982 A1
(43) Pub. Date: Sep. 11, 2025

(54) Method for Generating a Training Dataset

(71) Applicant: Robert Bosch GmbH, Stuttgart (DE)

(72) Inventors: Andreas Frischen, Leonberg (DE); Andreas Koelsch, Peiting (DE); Anke Giliard, Stuttgart (DE); Benjamin Moster, Niefern-Oeschelbronn (DE); Heiko Sgarz, Leonberg (DE); Jan Linus Steuler, Woelfersheim (DE); Lukas Fiederer, Balingen (DE); Uwe Troeltzsch, Roesrath (DE)

(21) Appl. No.: 19/071,380

(22) Filed: Mar. 5, 2025

(30) Foreign Application Priority Data
Mar. 11, 2024 (DE) 10 2024 202 234.9

(51) Int. Cl. G06N 5/022

(52) U.S. Cl. CPC G06N 5/022

(57) ABSTRACT

A computer-implemented method for generating a training dataset for training an artificial intelligence for operating a measuring device, in particular a wall diagnostic device, includes (i) receiving unclassified sensor data of at least one sensor unit of a measuring device by a classifier module, (ii) classifying the unclassified sensor data and providing classified sensor data by running the unclassified sensor data through the classifier module, and (iii) adding the classified sensor data to a training dataset.

This application claims priority under 35 U.S.C. § 119 to application no. DE 10 2024 202 234.9, filed on Mar. 11, 2024 in Germany, the disclosure of which is incorporated herein by reference in its entirety.

The present disclosure relates to a method for generating a training dataset for training an artificial intelligence for a wall diagnostic device.

### BACKGROUND

Diagnostic devices for diagnosing walls and detecting objects formed in the walls are known in the prior art.

It is a task of the present disclosure to provide an improved method for generating a training dataset for training an artificial intelligence of a wall diagnostic device.

The task is solved by the process set forth below. Advantageous embodiments are subject-matter set forth below.

### SUMMARY

According to one aspect, a computer-implemented method is provided for generating a training dataset for training an artificial intelligence to operate a measuring device, in particular a wall diagnostic device comprising:
receiving unclassified sensor data of at least one sensor unit of a measuring device via a classifier module, wherein the sensor data depicts a wall to be diagnosed with an object of an object type disposed in the wall in an object position;
classifying the unclassified sensor data and providing classified sensor data by running the unclassified sensor data through a classifier module, wherein the classifier module is embodied and configured as an artificial intelligence to perform object recognition based on unclassified sensor data and to determine the object position and/or object type of the object and classify the unclassified sensor data with respect to the object position and/or object type; and adding the classified sensor data to a training dataset.

This may achieve the technical advantage of providing an improved method for generating a training dataset for training an artificial intelligence to operate a measuring device, in particular a wall diagnostic device. For this purpose, classified sensor data is generated by a classifier module based on unclassified sensor data and added to a training dataset. The sensor data, unclassified as well as classified, here comprises a wall to be examined by the measuring device, including at least one object of an object type disposed in the wall in an object position.

The classification of the unclassified sensor data by the classifier module is carried out in relation to the object position and/or the object type of the objects disposed in the wall. In that the classifier module is embodied as an artificial intelligence and is configured to perform an object recognition of the objects disposed in the wall depicted by the sensor data based on unclassified sensor data, including determining an object position and/or object type, and to perform a classification of the unclassified sensor data with respect to the object position and/or the object type based on the object recognition, an automatic classification of unclassified sensor data may be achieved. Classified sensor data, in the sense of the application, is labeled sensor data as is known from the field of machine learning.

According to one embodiment, the unclassified sensor data comprises two-dimensional unclassified radar data, wherein the classifier module was trained, based on the unclassified radar data and taking into account additional classification information, to generate radar data classified in relation to the object position and/or the object type, wherein the classified sensor data comprises the classified radar data and depicts a wall having an object formed in the wall with respect to two spatial dimensions, and wherein the additional classification information comprises information regarding the object position and/or the object type with respect to a third spatial dimension.

This may achieve the technical advantage of achieving improved object recognition by the classifier module as well as, connected to this, improved classification of the unclassified sensor data by the classifier module. By training the classifier module on classified sensor data, reliable object recognition can be achieved by the classifier module. By considering additional classification information, the object recognition by the classifier module and the classification of the unclassified sensor data based thereon can be further improved.

According to one embodiment, the additional classification information was generated by performing running the classified two-dimensional radar data through a further artificial intelligence, and wherein the further artificial intelligence is trained to determine the object position and/or object type with respect to the three spatial dimensions based on the classified two-dimensional radar data.

By doing so, this may achieve the technical advantage that, by using the further artificial intelligence to generate the additional classification information, meaningful additional classification information may be provided that enables the training of the classification module to be performed.

According to one embodiment, the two spatial dimensions of the classified and/or unclassified two-dimensional radar data are defined by first and second directions perpendicular to each other and parallel to a surface of the wall depicted by the radar data, wherein the third spatial dimension is given by a third direction perpendicular to the first and second directions and directed into the wall, wherein the classified and/or unclassified radar data describes data from a plurality of scanning operations of the measuring device that run side-by-side along the second direction and along the first direction, wherein, in the scanning operations, the measuring device is moved along the first direction relative to the wall and radar data is captured, and wherein the radar data comprises information regarding a signal strength along the third direction directed into the wall.

This may achieve the technical advantage of the radar data depicting the wall to be examined in three spatial dimensions. The scanning operations of the measuring device are, in the sense of the application, a measurement by the measuring device while the measuring device is moving along the first direction relative to the wall. As the measuring device moves relative to the wall, radar data for the wall is captured. The radar data here comprises signal information in a third direction directed into the wall. By arranging a plurality of scanning operations along the second spatial direction, three-dimensional information for the wall to be examined can be achieved.

According to one embodiment, classification comprises:
determining the object position along the first direction based on the signal strength information along the third direction, wherein the object position is defined as a position along the first direction with maximum signal strength along the third direction.

This may achieve the technical advantage of enabling a precise determination of the object position along the first direction. By interpreting the object position along the first direction as the position with maximum signal strength along the third direction, precise object detection based on the radar data may be achieved.

According to one embodiment, the additional classification information comprises the information regarding signal strength along the third direction.

This may achieve the technical advantage of providing meaningful additional classification information.

According to one embodiment, the classified and/or unclassified radar data is illustrated as two-dimensional surface plots in which the data of the plurality of scanning operations are summarized and wherein the determination of the object position is performed jointly for the plurality of scanning operations.

This may achieve the technical advantage of enabling simple processing of radar data by the classifier module.

According to one embodiment, the classifier module is configured as a neural network.

This may achieve the technical advantage of providing a more powerful and reliable classifier module.

According to one embodiment, the classification of the sensor data is further performed with respect to an object depth and/or an object extent of the object.

This may achieve the technical advantage of enabling additional information regarding further features of the objects disposed in the walls to be examined to be considered in the training dataset, in the training of the diagnostic module and thus in the wall diagnostics of the diagnostic module.

According to one embodiment, object classes of the object type of the object comprise: Metal/non-metal object, low voltage cable, single phase AC signal cable, multi phase AC signal cable, wood beam, metal beam, plastic pipe, water filled plastic pipe, for example fresh water pipe, non-water filled plastic pipe, for example waste water pipe, and/or wherein the wall type classes of the wall type of the wall comprise: Concrete wall, plasterboard/drywall wall, brick wall and/or bricks of the wall, floor heating, wall heating.

This may achieve the technical advantage that a large number of different objects of different object types can be detected or classified. The measuring device or the diagnostic module can be trained hereby to detect and classify common objects installed in building walls. This allows for a particularly precise wall diagnostics in which the detected objects can be precisely and unambiguously assigned to the corresponding object classes.

By precisely classifying objects and providing the corresponding classification information to the user via the display unit, the most meaningful wall diagnostics possible is enabled. Because the user not only knows that an object is located within the wall and where it is, but also which object type the detected object is, the user can decide accordingly how to carry out further processing of the wall with respect to the detected object. Providing the object types of the object classification of the detected objects thus represents an essential area of the wall diagnostics, because the user can adjust the planned processing of the wall based on the indicated object type.

According to one aspect, a training dataset for training an artificial intelligence of a wall diagnostic measuring device is provided, wherein the training dataset was generated by the method for generating a training dataset for training an artificial intelligence for operating a measuring device according to one of the preceding embodiments.

Provided according to one aspect, is a computing unit configured to perform the method of generating a training dataset for training an artificial intelligence for operating a measuring device according to one of the preceding embodiments and/or the method of training an artificial intelligence of a measuring device.

Provided according to one aspect is a computer program product comprising instructions which, when the program is executed by a data processing unit, prompt it to perform the method for generating a training dataset for training an artificial intelligence to operate a measuring device according to one of the preceding embodiments, and/or the method for training an artificial intelligence of a measuring device.

### BRIEF DESCRIPTION OF THE DRAWINGS

Embodiments of the disclosure are described with reference to the following figures. The figures show:

FIG. 1 a schematic illustration of a measuring device according to one embodiment;

FIG. 2 a further schematic illustration of the measuring device according to a further embodiment;

FIG. 3 a further schematic illustration of the measuring device according to a further embodiment;

FIG. 4 a schematic illustration of a measurement of the measuring device according to one embodiment,

FIG. 5 a further schematic illustration of the measuring device according to a further embodiment;

FIG. 6 a schematic illustration of a system for generating a training dataset according to one embodiment,

FIG. 7 a flowchart of a method for generating a training dataset according to one embodiment,

FIG. 8 a graphical representation of a two-dimensional surface plot of radar data,

FIG. 9 a graphical representation of a two-dimensional surface plot of radar data, and

FIG. 10 a schematic illustration of a computer program product.

### DETAILED DESCRIPTION

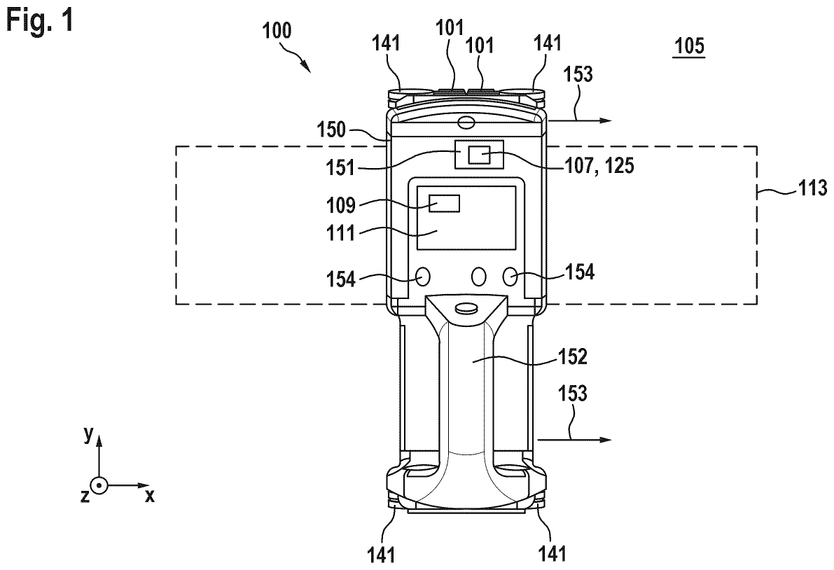

FIG. 1 shows a schematic illustration of a measuring device 100 according to one embodiment.

The present disclosure relates to a measuring device, in particular to a wall diagnostic device for examining walls 105 to be processed. Wall diagnostic devices are known in the prior art that are used to detect objects disposed in walls. Such devices allow a user to examine walls to be processed to search for objects disposed in the walls in order to be able to perform planned work, for example drilling in walls, based on this such that damage to the objects disposed in the walls can be avoided.

In the embodiment shown, the measuring device 100 comprises a housing 150 having a handle 152 for grasping of the measuring device 100 by a user, a display unit 111 for displaying diagnostic results 109 of the wall diagnostics, and controls 154 for switching the measuring device 100 to various operating modes.

According to the disclosure, the measuring device 100 comprises at least one radar sensor unit 101. By way of the radar sensor unit 101, radar signals may be transmitted towards the wall 105 to be examined and radar signals reflected by the wall 105 may be received.

For example, the radar sensor unit 101 may be configured as a narrow band radar detector device in the 2.4 GHz to 2.4835 GHz frequency range or as an ultra-wide band radar detector device in the 1.8 GHz to 5.8 GHz frequency range.

The measuring device 100 further comprises a diagnostic module 107 executable on a computing unit 151 of the measuring device 100 to perform the wall diagnostics. The diagnostic module 107 is configured to perform a corresponding diagnosis of the wall to be examined based on the radar data 103 of the radar sensor unit 101. The radar data 103 of the radar sensor unit 101 thereby depicts the wall 105 to be examined and, if applicable, objects 113 disposed within the wall 105.

The wall diagnostics carried out by the diagnostic module 107 comprises at least performing an object recognition. The object recognition here comprises an object detection and an object classification of the object 113 disposed in the wall 105. The object detection comprises at least the determination of an object position 115. The object position here describes the positioning of the object disposed in the wall 105 with respect to a reference system defined by the measuring device 100. The object classification of the detected object 113 comprises at least determining an object type 117 of the detected object 113.

The diagnostic results of the wall diagnostics determined in this way, i.e. at least the determined object position 115 and/or the determined object type 117 of the object 113 disposed in the wall 105, are subsequently presented in a display unit 111 of the measuring device 100 to a user of the measuring device 100. For example, the display unit 111 may be configured as a corresponding display and the diagnostic results 109 may be visually displayed. Additionally, the display of the diagnostic results 109 may be supported via audible and/or haptic signals. For example, the haptic signals may be realized via corresponding vibration signals.

The object 113 can be shown in the display, for example, by way of a corresponding icon. The object 113 can be shown in the corresponding object position 115 in the display. The object extension 121 may be visualized by a corresponding size of the displayed icon. The particular object type 117 of the object 113 may be visualized with a corresponding term or color highlighting of the icon, or by a specific shape of the icon representing the object 113.

Alternatively, the wall diagnostics may additionally comprise determining a wall type 123 in the form of a wall type classification of the wall 105 to be examined. The wall type 123 describes the respective type of the wall 105 to be examined. For example, the wall type may be associated with corresponding wall type classes, which may comprise: Concrete wall, plasterboard/drywall wall, brick wall and/or wall bricks, underfloor heating, wall heating or similar wall types found in buildings.

According to one embodiment, the diagnostic module 107 is further configured to determine an object depth 119 of the object 113 within the wall 105 based on the radar data 103. The object depth 119 is defined by a distance of the object formed in the wall 105 to a surface of the wall 105. The distance may be defined on the object side, for example with respect to an object surface or with respect to an object center point. The distance to the surface of the wall 105 describes a shortest distance defined by a direction perpendicular to the surface of the wall 105.

According to one embodiment, the diagnostic module 107 is further configured to determine an object extension 121 of the object 113 in at least one predefined direction based on the radar data 103. The object extension 121 of the object 113 describes a spatial extension of the object 113 in at least one spatial direction, preferably in two spatial directions, particularly preferably in three spatial directions. The object 113 may be described here as a one-dimensional, two-dimensional, or three-dimensional object 113.

In conventional use, the measuring device 100 is placed on the surface of the wall 105 to be examined. Radar signals are transmitted towards the wall 105 and radar signals reflected from the wall 105 or the objects 113 disposed there are received via the radar sensor unit 101. This radar data 103 of the radar sensor unit 101 is used by the diagnostic module 107 to perform the wall diagnostics described above and to determine corresponding diagnostic results 109.

For example, diagnostic results 109 may comprise the object position 115 and/or object type 117 of the object 113 disposed in the wall 105. Alternatively or additionally, the diagnostic results 109 may comprise the wall type 123 of the wall 105 and/or the object depth 119 and/or the object extension 121 of the object 113.

The diagnostic results 109 configured in this manner may subsequently be displayed to a user of the measuring device 100 in a display unit 111 of the measuring device 100. The display unit 111 can be configured as a corresponding display, for example. The diagnostic results 109 may be displayed in graphical or textual form in the display unit 111.

According to one embodiment, the measuring device 100 further comprises a motion detection unit 141. The motion detection unit 141 may be used to detect movement of the measuring device 100 relative to the wall 105. The motion detection unit 141 may comprise, for example, at least one roller element for this purpose. When the roller element is placed on the wall surface of the wall 105, movement of the measuring device 100 relative to the wall 105 can be detected when the measuring device 100 moves along a direction of movement 153 by rolling the roller element. Alternatively, the motion detection unit 141 may have a different configuration by which a relative movement of the measuring device 100 relative to the wall 105 can be detected.

By moving the measuring device 100 relative to the wall 105, radar data 103 of the radar sensor unit 101 may be captured for a plurality of different positions of the measuring device 100 relative to the wall 105. This allows a larger spatial area of the wall 105 to be examined than that given by the effective range of the radar sensor unit 101. This allows for objects 113 to be captured that have a greater spatial extent than the effective range of the radar sensor unit 101.

While the measuring device 100 moves along the direction of movement 153, radar data 103 of the radar sensor unit 101 may be captured continuously. The wall diagnostics may be evaluated by the diagnostic module 107 based on this radar data 103 while the measuring device 100 is moving along the direction of movement 153. This allows for accelerated wall diagnostics, taking into account the positioning of the measuring device 100 relative to the wall 105.

According to its embodiment, the diagnostic module 107 is configured as a correspondingly trained artificial intelligence 125. The artificial intelligence 125 is trained to perform the above-described wall diagnostics based on the radar data 103 of the radar sensor unit 101 and to determine at least the object position 115 and the object type 117 of an object 113 disposed in the wall 105. The object classification or determination the object type 117, respectively, comprises assigning the detected object 113 to predefined object classes.

The object classes may comprise: Metal/non-metal object, low voltage cable, single phase AC signal cable, multi phase AC signal cable, wood beam, metal beam, plastic pipe, water filled plastic pipe, for example fresh water pipe, non-water filled plastic pipe, for example waste water pipe, or other elements commonly installed in building walls.

Further, the artificial intelligence 125 may be trained to determine the wall type 123 of the wall 105 to be examined at least based on the radar data 103 of the radar sensor unit 101. Possible wall types 123 may comprise: Concrete wall, plasterboard/drywall wall, brick wall and/or individual bricks of the brick wall, underfloor heating, wall heating or other similar wall types commonly installed in buildings.

According to one embodiment, in addition to the radar sensor unit 101, the measuring device 100 may comprise further additional sensors by way of which additional physical variables are detectable. For example, the measuring device 100 may comprise an induction sensor and/or an eddy current sensor and/or a capacitance sensor and/or an AC current sensor and/or an NMR sensor and/or an ultrasonic sensor or other sensors commonly used in wall diagnostic devices.

The diagnostic module 107, in particular the corresponding trained artificial intelligence 125, may be configured to perform wall diagnostics based on the radar data 103 of the radar sensor unit 101 and taking into account the additional sensor information of the further sensors described above. The additional information of the additional sensors mentioned above can in particular be used for object recognition of the objects 113 disposed in the walls 105. The additional sensor information may possibly provide improved detection of the objects 113 and may possibly provide improved classification of the objects 113.

In particular, for example, the material of the objects 113, for example as a metallic or non-metallic material, can be improved and classified by using the additional sensor information.

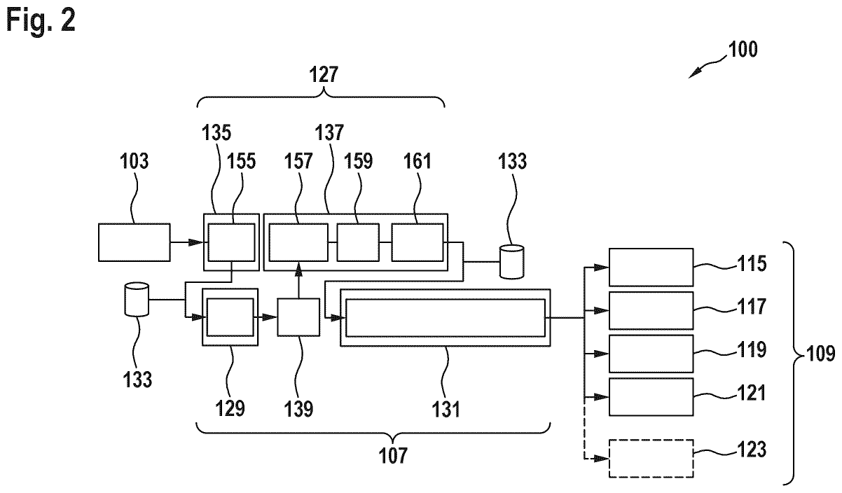

FIG. 2 shows another schematic representation of the measuring device 100 according to a further embodiment.

In the embodiment shown, the measuring device 100 comprises a pre-processing module 127 in addition to the diagnostic module 107. For wall diagnostics, the measuring device 100 first receives the radar data 103 of the radar sensor unit 101. Pre-processing of the receiving radar data 103 is performed via the pre-processing module 127. For example, via pre-processing of the pre-processing module 127, the radar data may be brought into a corresponding data structure required for wall diagnostics by the diagnostic module 107.

As described above, during wall diagnostics, the diagnostic module 107 generates the diagnostic results 109 described above. For example, the diagnostic results 109 may comprise the object position 115 and/or object type 117 and/or object depth 119 and/or object extension 121 of an object 113 disposed in the wall 105 to be examined and/or the wall type 123 of the wall 105 to be examined. The correspondingly generated diagnostic results 109 may subsequently be displayed in the display unit 111 of the measuring device 100.

According to one embodiment, in addition to the radar data 103 of the radar sensor unit 101, the additional sensor information of the additional sensors described above may be included in the wall diagnostics of diagnostic module 107. A corresponding pre-processing of the additional sensor information may be performed accordingly by the pre-processing module 127.

In the embodiment shown, the diagnostic module 107 comprises a wall type classification module 129 and an object recognition module 131. The pre-processing module 127 comprises a first pre-processing module 135 and a second pre-processing module 137. The first pre-processing module 135 comprises an S matrix reduction 155. The second pre-processing module 137 comprises a background correction 157, an inverse Fast Fourier transformation 159, and a focusing and migration 161. In the pre-processing of the radar data 103 by the pre-processing module 127, the radar data 103 is first pre-processed by the first pre-processing module 135 and the S-matrix reduction 155 contained therein.

When doing so, the first pre-processing module 135 generates input data 133 based on the radar data 103. The input data 133 serves as input data for the wall type classification module 129. The wall type classification module 129 performs a wall type classification of the wall 105 to be examined based on the input data 133 and generates wall type information 139. The wall type information 139 contains the wall type 123 of the wall 105 to be examined, as determined in the wall type classification.

Subsequently, the second pre-processing module 137 performs pre-processing based on the radar data 103 and the wall type information 139. A background correction 157 of the radar data 103 is performed during this, taking into account the wall type 123 determined in the wall type information 139. Depending on the wall type 123 of the wall 105 to be examined, different effects on the radar data 103 can occur.

These effects, which are primarily based on the respective wall type 123 and can affect object recognition, can be corrected by the background correction 157. After the background correction has been performed, further pre-processing can be carried out by performing the inverse Fast Fourier transformation 159 or focusing and migration 161, respectively, and input data 133 can be created for the object recognition module 131 once again. Based on the input data 133 provided by the second pre-processing module 137, the object recognition module 133 performs the object recognition of the object 113 disposed in the wall 105 to be examined and determines at least the object position 115 and the object type 117 of the respective object 113. Additionally, the object depth 119 and the object extension 121 may be determined by the object recognition module

According to one embodiment, the diagnostic module is further configured to determine an object depth of the object within the wall based on the radar data, wherein the object depth is defined by a distance of the object formed in the wall to a surface of the wall.

The pre-processing is optional. Depending on the algorithm used for the diagnostic module 107, completely unprocessed radar echoes of different frequencies may be used as radar data 103 and as input data for the diagnostic module 107. Alternatively, radar data 103 processed via multiple steps may be used. The pre-processing steps comprise, for example, the transformation of the signals from the frequency domain to the time or distance domain, background deduction, noise removal, and normalization of the signals. For radar data 103 which is available in the form of complex numbers, only the absolute value can be processed. Alternatively or additionally, the phase information may be considered.

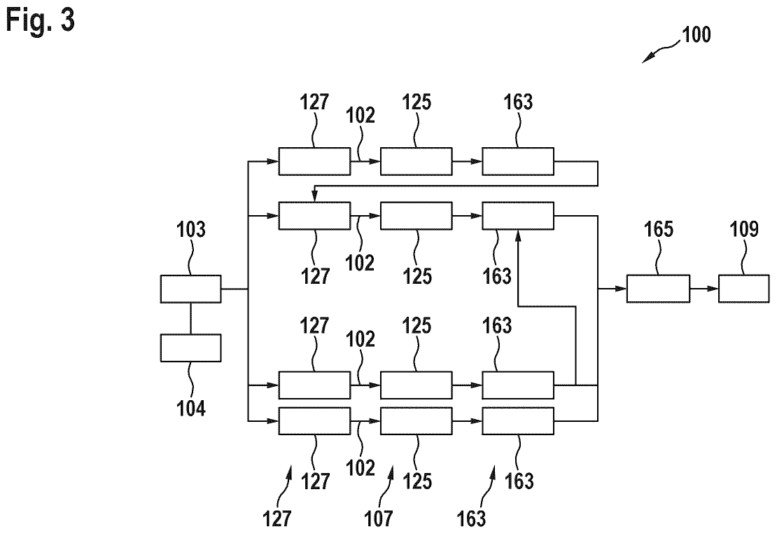

FIG. 3 shows a further schematic representation of the measuring device 100 according to a further embodiment.

In the embodiment shown, the diagnostic module 107 comprises a plurality of parallel processing paths 102. Each processing path 102 includes a pre-processing module 127, the diagnostic module 107, for example, comprising the wall type classification module 129 and/or the object recognition module 131 according to the embodiment in FIG. 2, and a post-processing module 163.

In FIG. 3, primarily the radar data 103 is shown as input data for the wall diagnostics. In addition to the radar data shown, however, the additional information of the additional sensors may also serve as input data for the wall diagnostics. Here, the different information from the different types of sensors in the different parallel processing paths 102 can be processed and the corresponding wall diagnostics performed separately on the different sensor information. Upon completion of the wall diagnostics, a summary module may be used to assemble a summary of the individual sub-analysis results to form the diagnostic results 109 of the wall diagnostics.

Alternatively or additionally, different sub-aspects of the wall diagnostics may be performed by the different processing paths 102 based on the same sensor information.

For example, the individual processing paths 102 may process different radar data 103 captured during movement of the measuring device 100 relative to the wall 105 for different positions of the measuring device 100 relative to the wall 105. The radar data 103, thus representing different regions of the wall 105 and captured sequentially in time as the measuring device 100 moved relative to the wall 105, may then be processed in the different processing paths 102 by the modules shown.

The different processing paths perform a stand-alone wall diagnostics in this respect, comprising at least determining the object position 115 and/or the object type 117 of the object 113 disposed in the wall 105.

The summary module 165 may summarize the sub-results provided in the individual processing paths 102 of the stand-alone wall diagnostics of the different regions of the wall 105 into a contiguous diagnostic result 109. The contiguous diagnostic result here describes the wall diagnostics of a contiguous spatial area that was covered during movement of the measuring device 100 relative to the wall 105 and depicted by the corresponding captured radar data 103. The parallel processing of the radar data 103 or additional sensor information 104 of the additional sensor elements in the different processing paths 102 thus enables accelerated wall diagnostics.

Alternatively, various wall diagnostic functions may also be performed in the different processing paths 102. For example, in one processing path 102, the wall type classification and the determination of the wall type 123 of the wall 105 to be examined can be performed. In another processing path 102, object recognition of the object disposed in the wall 113 can be performed. The object detection can be performed with the determination of the object position 115 and the object classification can be performed with the determination of the object type 113 in one processing path 102.

Alternatively, the object detection and object classification may then also be performed in two separate processing paths 102. In further processing paths 102, the object depth determination, i.e., the determination of the object depth 119 and/or the determination of the object extension 121 may respectively be carried out. In the summary module 165, the various sub-results of the wall diagnostics may be summarized into corresponding diagnostic results 109.

The diagnostic module 107 can be divided into different artificial intelligences 125, as already shown in the embodiment in FIG. 2. For example, the diagnostic module 107 may comprise a wall type classification module 129 and an object recognition module 131. The object recognition module may in turn be divided into an object detection module and an object classification module. The diagnostic module 107 may further comprise an object depth determination module and object extension module, respectively configured to determine the object depth 119 and the object extension 121.

The respective modules may each be configured as stand-alone artificial intelligences 125, for example, neural networks. Alternatively, the various modules may form portions of an overall artificial neural network that are connected to an overall neural network according to structures known in the prior art.

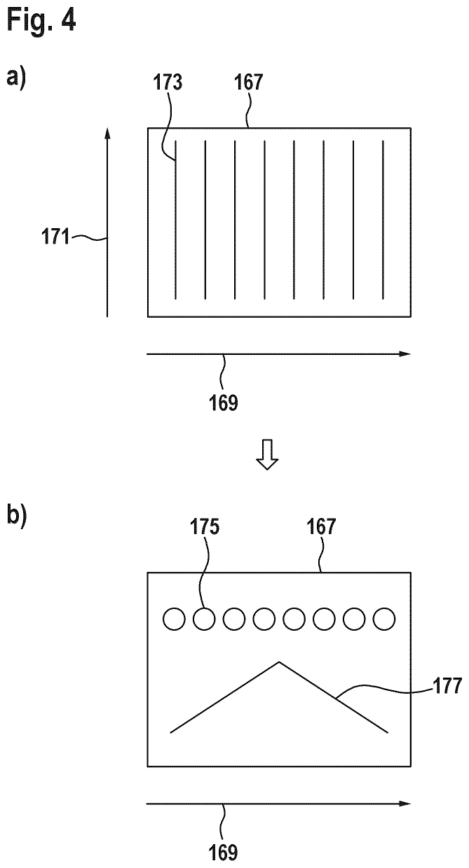

FIG. 4 shows a schematic illustration of a measurement of the measuring device 100 according to one embodiment.

For pre-processing, the radar data 103 or the additional sensor information 104 of the remaining sensors may be normalized, in particular to numerically stabilize the subsequent steps performed by the diagnostic module 107 during wall diagnostics. For example, an amplitude and/or offset compensation may be performed for this purpose. Further, to reduce interference, filtering of the radar data 103 may be carried out, and to reduce the data rate the corresponding sensor data may be sampled. Further, the radar data 103 or the additional sensor information 104 may be transformed to the respective required frequency range or time range. Methods known from the prior art can be used for this purpose.

Further, the captured radar data 103 or additional sensor information 104 may be divided into temporal or spatial windows 167. Temporal windows 167 may be generated by recording the radar data 103 or the additional sensor information or the pre-processed radar data 103 over a fixed time interval. Spatial windows 167, on the other hand, may be generated from a mapping of the radar data 103 or additional sensor information 104 to positions of the measuring device 100 relative to the wall 105 along the direction of movement 153.

Graph a) of FIG. 4 shows such a data matrix resulting from the steps described above. The data matrix of the window 167 shown in graph a) shows a plurality of sensor data, which may comprise, for example, radar data 103 or additional sensor information 104 of the further sensors plotted along a frequency channel axis 171 or along a space/time axis 169, respectively.

A width of the temporal windows 167 may be selected such that different sampling rates of the sensors may be balanced and a new window 167 may be provided frequently enough so that a display of the diagnostic results 109 of the wall diagnostics in the display unit 111 may be shown without too great of a time delay while the measurement is being performed or shortly after the measurement of the measuring device 100 ends.

A rate of 2 to 20 windows per second of the data recording of the sensor data may be advantageous for this purpose. For spatial windows, the spatial sampling rates can be selected to achieve the desired local accuracy. Advantageously, 1 mm to 1 cm sampling rates can be used. This means that corresponding sensor data is captured every 1 mm to 1 cm of movement of the measuring device 100 along the direction of movement 153.

A width of the spatial windows 167 may be selected such that contiguous information relating to an object 113 is contained in a window. Advantageously, a width of the respective spatial windows 167 can be 1 cm to 20 cm. This results in 4 to 100 measured values per window 167. This allows for further efficient algorithmic processing of the correspondingly recorded radar data 103 or additional sensor information by the diagnostic module 107.

A further temporal window 167 or spatial window 167 can be provided as soon as one or more scan points are available.

The diagnostic module 107 may be oriented such that a matrix corresponding to the window size of the respective spatial or temporal window 167 may be included as input data, for example of each processing path 102 of the embodiment in FIG. 3 as well. According to the embodiment of FIG. 2, the corresponding input data can comprise the respective pre-processed sensor data, i.e. radar data 103 and additional sensor information 104 of the additional sensors.

As stated above, wall diagnostics may be performed by the diagnostic module 107 based on a correspondingly trained artificial intelligence. Alternatively, different processing paths may also be calculated by rule-based algorithms. A combination of artificial intelligence and a rule-based algorithm is also possible within a processing path 102 in the form of a parallel connection or concatenation.

The diagnostic results 109 of the wall diagnostics may be implemented as numeric values, vectors, or matrices. Further, the probability of detection, or for the wall type classification and/or the object classification, respectively, a probability of the specified object classes and/or wall type classifications can be given for the object detection. The same may apply to the position and/or depth determination, for which corresponding probability values can also be given.

If, in addition to the radar data 103, the additional sensor information of the further sensor types is processed in a processing path 102, these may either be merged within the artificial intelligence 125 or combined by rule-based combinations.

In the post-processing of each processing path 102, of the embodiment of FIG. 3, multiple algorithm results based on multiple windows 167 may be summarized by the summary module 165. This summary can in particular be realized by majority formation, sum formation or also by multiplication of successive probability values.

Further, by clustering multiple results, for example, it is possible to detect which objects of multiple detected objects lying close to one another are the same object so that they are not incorrectly detected multiple times.

Likewise, it is possible to multiply a weighting function 177 when summarizing the results from multiple windows 167. Advantageously, the diagnostic sub-results 175 corresponding to corresponding data points in the space may be weighted with respect to positioning of the diagnostic sub-results 175 relative to a center point of the respective window 167. This is illustrated by way of example in graph b), in which the individual diagnostic sub-results 175 are weighted according to the weighting function 177 shown with respect to the center point of the window 167 shown.

According to one embodiment, the results of one processing path 102 after post-processing 163 may influence the extension of another processing path 102. Here, weighting parameters may be adjusted that may depend on the particular result from the processing path 102 for each window.

For example, the result of an object classification in which the object type 117 of an object disposed in the wall 105 is defined can be utilized to increase the weight of a wall type classification in which the wall type 123 of the respective wall 105 is determined in the post-processing at locations without objects 113, because the respective radar data 103 at these locations are less influenced by reflections of the objects 113.

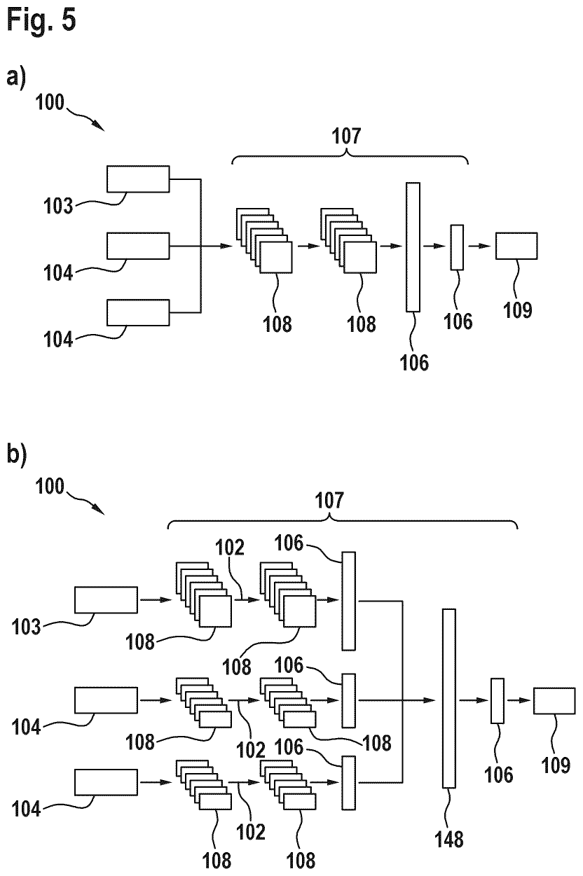

FIG. 5 shows a further schematic representation of the measuring device 100 according to a further embodiment.

Graphs a) and b) of FIG. 5 show two different alternatives of a joint data processing of radar data 103 and additional sensor information 104 by the diagnostic module 107.

Graph b) illustrates a joint processing of the radar data 103 and the additional sensor information 104 of the additional sensors by the diagnostic module 107. For this purpose, the radar data 103 and the additional sensor information 104 are collectively used as input data of the diagnostic module 107 configured as an artificial intelligence, in particular as an artificial neural network. The diagnostic module 107 here comprises multiple convolutions 108 and multiple dense layers 106. The radar data 103 and the additional sensor information 104 are processed jointly as input data via the convolutions 108 and dense layers 106. The aforementioned diagnostic results 109 are created as output data of the diagnostic module 107, based on this.

In graph b), in contrast, the radar data 103 and the additional sensor information 104 are used as stand-alone input data of the diagnostic module 107. The diagnostic module 107 becomes multiple processing paths 102. The processing paths 102 each comprise multiple convolutions 108 and at least one dense layer 106. In the various processing paths 102, wall diagnostics are performed separately by the diagnostic module 107 based on the radar data 103 and the additional sensor information 104, respectively.

In an additional concatenation layer 148, the partial results of the partial diagnoses of the different processing paths 102 are combined and fed to a final dense layer 106. The output data of the diagnostic module 107 corresponds to the diagnostic results 109 described above.

The correspondingly configured diagnostic module 107 is designed to perform wall diagnostics as described above, including the features described above, based on the radar data 103 and the additional sensor information 104.

In the embodiment shown, the diagnostic module 107 is configured as an artificial neural network, in particular as a convolutional network. Corresponding network architectures with convolutions 108, dense layers 106, and concatenation layers 148 are known in the prior art.

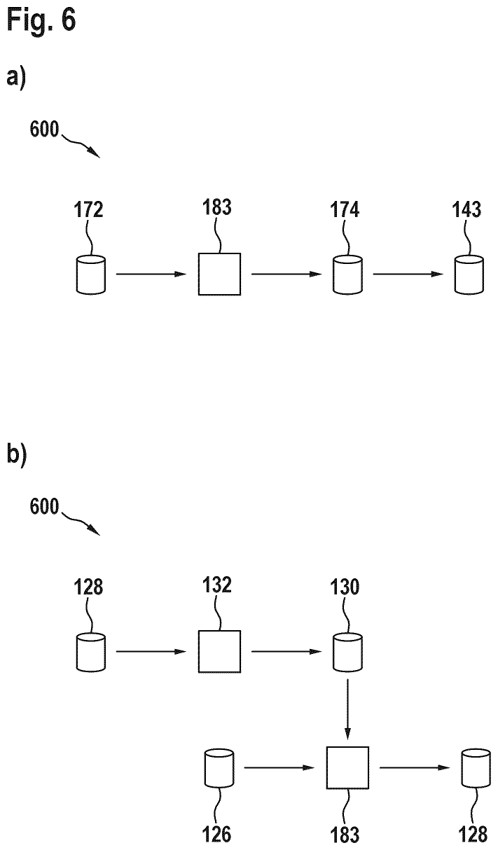

FIG. 6 shows a schematic representation of a system 600 for generating a training dataset 143 according to one embodiment.

In the embodiment shown, the system for generating a training dataset 143 comprises at least one classifier module 183. The classifier module 183 is embodied as a trained artificial intelligence and is configured to generate classified sensor data 174 for the training dataset 143 based on unclassified sensor data 172. The classifier module 183 is trained to perform object recognition of objects 113 disposed in the wall 105 depicted by the sensor data 172 based on the unclassified sensor data 172. The object recognition comprises an object detection with determination of the object position 115 and/or an object classification with determination of the object type 117 of the respective object 113.

In the embodiment in graph b), the system 600 furthermore comprises a further artificial intelligence 132 in addition to the classifier module 183. The further artificial intelligence 132 is trained to determine additional classification information 130 based on classified radar data 128. The classified radar data 128 here depicts walls 105 and objects 113 disposed in them to be examined. The classified radar data 128 is thereby classified at least in relation to the object position 115 and/or the object type 117 of the objects 113 disposed in the depicted walls 105. The classified radar data 128 are in two-dimensional form and comprise a plurality of scanning operations of the measuring device 100 that run along the first spatial direction, wherein the plurality of scanning operations are disposed adjacent one another along a second direction. The first and second directions run along the X and Y-axis of the coordinate system of FIG. 1 and are thus arranged parallel to the surface of the wall 105 to be examined.

The further artificial intelligence 132 is trained, despite application to the two-dimensional radar data 128, to determine the object position 115 of the objects 113 disposed in the wall 105 in three spatial directions X, Y, Z. The additional classification information 130 generated by the further artificial intelligence 132 describes the object position 115 and/or the object type 117 with respect to the third spatial direction. The third spatial direction is aligned along the Z-axis of the coordinate system shown in FIG. 1 and thus runs into the depicted wall 105.

The further artificial intelligence 132 is trained to determine the object recognition of the objects 113 disposed in the walls 105 depicted by the radar data 128 in all three spatial directions based on the classified radar data 128. The further artificial intelligence 132 is thus at least configured to determine the object position 115 of the objects 113 with respect to the three spatial directions X, Y, Z of the coordinate system shown in FIG. 1 based on the two-dimensional classified radar data 128.

The classifier module 183 is now trained based on unclassified radar data 126, taking into account the additional classification information 130 provided by the further artificial intelligence 132. The unclassified radar data 126, in turn, is in two-dimensional form and comprises a plurality of radar data captured in a plurality of scanning operations 140. The scanning operations 140 describe measurements of the measuring device 100 in which the measuring device 100 is moved along the first spatial direction X relative to the wall to be examined 105, during which it captures radar data 103. The measurements of the scanning operations are performed for various locations on the wall 105 disposed along the second spatial direction Y. This makes it possible to examine a two-dimensional spatial area of the wall 105 and map it using the correspondingly captured radar darts. For this purpose, the data captured in the plurality of different scanning operations 140 are disposed adjacent to each other along the second spatial direction Y and summarized into the two-dimensional radar data.

Based on the two-dimensional unclassified radar data 126 and in consideration of the additional classification information 130, the classifier module Z is trained according to prior art training methods to generate classified radar data 128. The radar data classified 128 by the correspondingly trained classifier module 183 is thereby classified at least in relation to the object position 115 and/or the object type 117 of the objects 113.

The classified radar data 128 used in the graph d) for training the further artificial intelligence 132 and the classified radar data 128 generated during training of the classifier module 183 need not be the same radar data but may instead represent different data.

The unclassified radar data 126 used for training the classifier module 183 may have been generated by a plurality of different measurements of a plurality of different measuring devices 100.

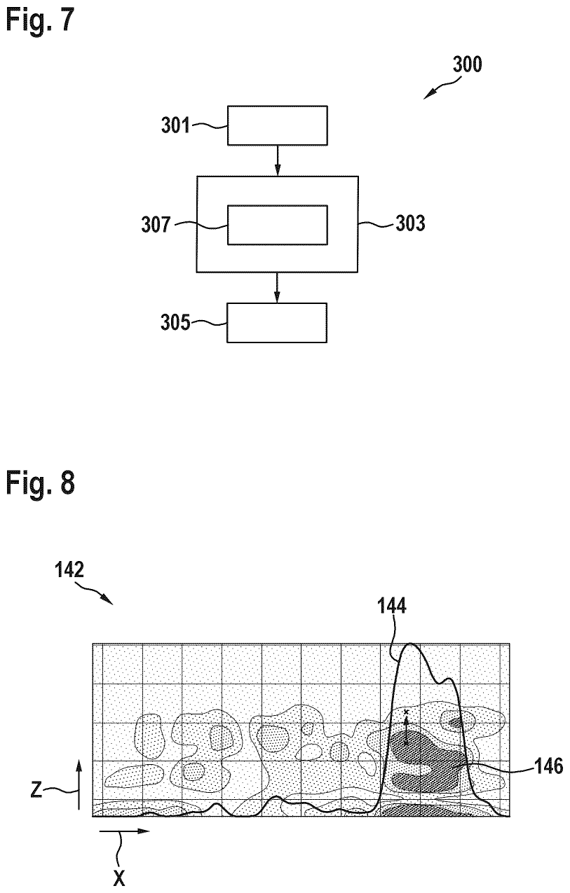

FIG. 7 shows a flowchart of a method 300 for generating a training dataset 143 according to one embodiment.

To generate a training dataset 143, in a first method step 301, unclassified sensor data 172 of at least one sensor unit of a measuring device 100 is initially received by a classifier module 183. The sensor data 172 depicts the wall 105 to be diagnosed and the objects 113 disposed therein. The sensor data 172 may comprise radar data 103 and additional sensor information 104.

In a further method step 303, the unclassified sensor data 172 is classified by the classifier module 183 and classified sensor data 174 is generated. The classifier module 183 is embodied as appropriately trained artificial intelligence and is configured to perform an object recognition based on unclassified sensor data 172 and to determine the object position 115 and/or the object type 117 of the objects 113. The classifier module 183 is configured to perform a corresponding classification of the unclassified sensor data 172 with respect to the object position 115 and/or the object type 117 of the objects 113 based on the object recognition.

According to one embodiment, the unclassified sensor data 172 is two-dimensional unclassified radar data 126. The classifier module 183 is trained on the unclassified radar data to generate classified radar data 128 with respect to the object position 115 and/or the object type 117. The unclassified radar data 126 and the classified radar data 128 comprise two-dimensional radar data, and depict the wall 105 to be examined with respect to a first spatial direction X and a second spatial direction Y arranged perpendicular thereto. The first and second spatial directions X, Y are parallel to a surface of the wall 105. The additional classification information 130 comprises information regarding the object position 115 and/or the object type 117 in relation to a third spatial direction Z perpendicular to the first and second spatial directions X, Y.

According to one embodiment, the classification information 130 was generated by running the classified two-dimensional radar data 128 through a further artificial intelligence 132. The further artificial intelligence 132 is trained to determine the object position 115 and/or the object type 117 relative to the three spatial dimensions X, Y, Z based on the classified two-dimensional radar data 128.

The classified and/or unclassified radar data 126, 128 comprises data of a plurality of scanning operations 140 of the measuring device 100 that run side-by-side along the second direction Y and extend along the first direction X. The scanning operations 140 of the measuring device 100 here describe measurements of the measuring device 100 while moving the measuring device 100 along the first direction X, wherein corresponding radar data 103 is recorded during the measurement. The radar data 103 comprises information regarding a signal strength along the third spatial direction directed into the wall 105.

In another method step 307, the classification 303 comprises determining the object position 115 along the first direction X based on the signal strength information along the third direction Z, wherein the object position 115 is defined as a position along the first direction X with maximum signal strength along the third direction Z.

In another method step 305, the sensor data 174 classified by the classifier module 183 is merged into the training dataset 143.

FIG. 8 shows a graphical representation of a two-dimensional surface plot 142 of radar data 103.

FIG. 8 shows a surface plot 142 of two-dimensional radar data 103. The surface plot 142 shows radar data with respect to the first spatial direction X that runs parallel to the surface of the wall 105 to be examined and runs along the third spatial direction Z that is pointing into the wall. The surface plot 142 further shows a measurement signal 146. The measurement signal 146 is disposed along the first spatial direction X. A signal strength of the measurement signal 146 is plotted along the third spatial direction Z. Further, the surface plot 142 shows an envelope of the signal strength 144.

According to one embodiment, the object position 115 of an object 113 disposed in the wall 105 depicted by the radar data of the surface plot 142 may be determined along the first spatial direction X based on the signal strength of the measurement signal 146 in the third spatial direction Z. The object position 115 of the object 113 represented by the measurement signal 146 along the first spatial direction X can thus be identified as the position along the first spatial direction X in which the signal strength of the measurement signal 146 assumes a maximum value with respect to the third spatial direction Z. The maximum value is represented by the peak of the envelope 144. The respective object position 115 with respect to the first direction X is represented by the X symbol within the surface plot 142.

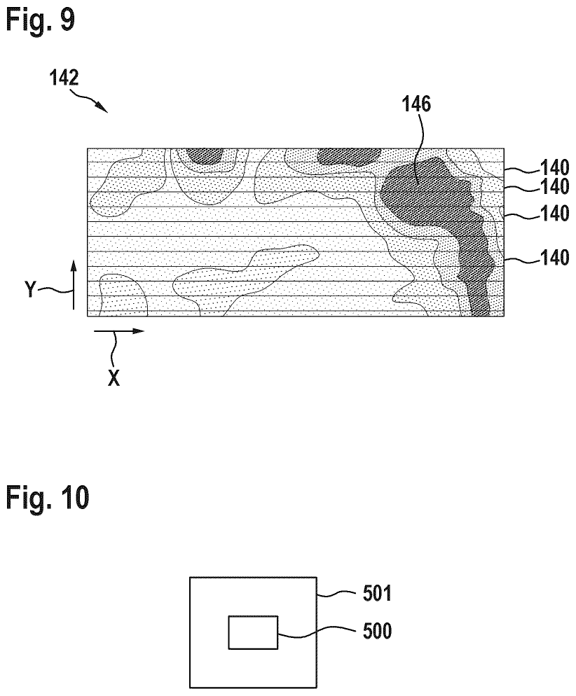

FIG. 9 shows a graphical representation of a two-dimensional surface plot 142 of radar data 103.

FIG. 9 shows a further surface plot 142. The surface plot 142 shows radar data extending along the first spatial direction X and the second spatial direction Y. The surface plot 142 in turn shows a measurement signal 146.

The surface plot 142 is formed by a plurality of scanning operations 140 disposed adjacent one another along the second spatial direction Y. The scanning operations 140 extend along the first spatial direction X. Thus, to create the surface plot 142, radar data is captured while carrying out multiple scanning operations 140 by moving the measuring device 100 along the first direction X and capturing radar data 103 during this time. To generate a plurality of scanning operations 140, the measuring device 100 is placed at various positions along the second spatial direction Y. Starting from these positions, the measuring device 100 is moved along the first spatial direction X to record the data of the scanning operations 140.

FIG. 10 shows a schematic representation of a computer program product 500 comprising instructions that, when the program is executed by a data processing unit, cause the latter to perform the method 300 for generating a training data set 143.

In the embodiment shown, the computer program product 500 is stored on a storage medium 501. The storage medium 501 can in this case be any desired storage medium known from the prior art.

What is claimed is:

1. A computer-implemented method for generating a training dataset for training an artificial intelligence for operating a measuring device, comprising:
receiving unclassified sensor data of at least one sensor unit of a measuring device by a classifier module, wherein the sensor data depicts a wall to be diagnosed with an object of an object type disposed in the wall in an object position;
classifying the unclassified sensor data and providing classified sensor data by running the unclassified sensor data through the classifier module, wherein the classifier module is embodied and configured as an artificial intelligence to perform an object recognition based on unclassified sensor data and to determine the object position and/or the object type of the object and classify the unclassified sensor data with respect to the object position and/or the object type; and
adding the classified sensor data to a training dataset.

2. The method of claim 1, wherein:
the unclassified sensor data comprises two-dimensional unclassified radar data,
the classifier module was trained based on the unclassified radar data and taking into account additional classification information, to generate radar data classified in relation to the object position and/or the object type,
the classified sensor data comprises the classified radar data and depicts a wall having an object formed in the wall with respect to two spatial dimensions, and
the additional classification information comprises information regarding the object position and/or the object type relative to a third spatial dimension.

3. The method of claim 1, wherein:
the additional classification information was generated by running the classified two-dimensional radar data through a further artificial intelligence, and
the further artificial intelligence is trained to determine the object position and/or the object type relative to the three spatial dimensions based on the classified two-dimensional radar data.

4. The method of claim 3, wherein:
the two spatial dimensions of the classified and/or unclassified two-dimensional radar data are defined by first and second directions which are perpendicular to each other and parallel to a surface of the wall depicted by the radar data,
the third spatial dimension is given by a third direction perpendicular to the first and second directions and directed into the wall,
the classified and/or unclassified radar data describe data of a plurality of scanning operations of the measuring device that run side-by-side and along the first direction and along the second direction,
in the scanning operations, the measuring device is moved along the first direction relative to the wall and radar data is captured, and
the radar data comprises information regarding a signal strength along the third direction directed into the wall.

5. The method of claim 1, wherein the classifying comprises:
determining the object position along the first direction based on the signal strength information along the third direction, wherein the object position is defined as a position along the first direction with maximum signal strength along the third direction.

6. The method of claim 2, wherein the additional classification information comprises the signal strength information along the third direction.

7. The method of claim 1, wherein the classified and/or unclassified radar data is represented as two-dimensional surface plots in which the data of the plurality of scanning operations is summarized, and wherein the determination of the object position is performed jointly for the plurality of scanning operations.

8. The method of claim 1, wherein the classification of the unclassified sensor data is further performed in relation to an object depth and/or an object extension of the object.

9. The method of claim 1, wherein object classes of the object type of the object comprise: metal/non-metal object, low voltage cable, single phase AC signal cable, multi phase AC signal cable, wood beam, metal beam, plastic pipe, water filled plastic pipe, non-water filled plastic pipe, and/or wherein the wall type classes of the wall type of the wall comprise: concrete wall, plasterboard/drywall wall, brick wall and/or bricks of the wall, floor heating, wall heating.

10. A training dataset for training an artificial intelligence of a wall diagnostic measuring device, wherein the training dataset was generated according to the method for generating a training dataset according to claim 1.

11. A computing unit configured to perform the method of generating a training dataset for training an artificial intelligence for operating a measuring device of claim 1.

12. A computer program product comprising instructions which, when the program is executed by a data processing unit, prompt the data processing unit to perform the method for generating a training dataset for training an artificial intelligence to operate a measuring device according to claim 1.

13. The method of claim 1, wherein the measuring device is a wall diagnostic device.

14. The method of claim 9, wherein:
the water filled plastic pipe includes a fresh water pipe, and
the non-water filled plastic pipe includes a waste water pipe.
